(19) United States
(12) Patent Application Publication
(10) Pub. No.: US 2023/0352723 A1
(43) Pub. Date: Nov. 2, 2023

(54) SYSTEM AND METHOD FOR ESTIMATING PRESSURE DISTRIBUTION OF A BATTERY CELL

(71) Applicants: HYUNDAI MOTOR COMPANY, Seoul (KR); KIA CORPORATION, Seoul (KR); SEOUL NATIONAL UNIVERSITY R&DB FOUNDATION, Seoul (KR)

(72) Inventors: Yong Seok Choi, Seoul (KR); Soon Chul Byun, Yongin-si (KR); Byeng Dong Youn, Seoul (KR); Won Gon Kim, Seoul (KR); Hwa Yong Jeong, Seoul (KR)

(73) Assignees: HYUNDAI MOTOR COMPANY, Seoul (KR); KIA CORPORATION, Seoul (KR); SEOUL NATIONAL UNIVERSITY R&DB FOUNDATION, Seoul (KR)

(21) Appl. No.: 18/079,695

(22) Filed: Dec. 12, 2022

(30) Foreign Application Priority Data
May 2, 2022 (KR) 10-2022-0054203

(51) Int. Cl. H01M 10/04; H01M 10/0562; H01M 10/0585

(52) U.S. Cl. CPC H01M 10/0468; H01M 10/0562; H01M 10/0585; H01M 10/0481

(57) ABSTRACT

A system and a method for estimating pressure distribution of a battery cell evaluate distribution of pressure applied to the battery cell due to applied loads during the pressure test of the battery cell. The method includes disposing the battery cell in a pressing apparatus and pressing the battery cell, measuring strains by strain sensors provided in the pressing apparatus, and estimating a pressure distribution applied to the battery cell based on the strains.

### CROSS-REFERENCE TO RELATED APPLICATION

This application claims under 35 U.S.C. § 119(a) the benefit of priority to Korean Patent Application No. 10-2022-0054203, filed on May 2, 2022, the entire contents of which are incorporated herein by reference.

### BACKGROUND

### (a) Technical Field

The present disclosure relates to a system and a method for estimating pressure distribution of a battery cell. More particularly, it relates to a system and a method for estimating pressure distribution of a battery cell when the battery cell is pressed.

### (b) Background Art

Using a solid electrolyte instead of a liquid electrolyte used in a lithium-ion battery, an all-solid-state battery is a next generation secondary battery, which may secure capability and safety limiting the conventional or existing secondary batteries. Therefore, research on the all-solid-state battery is actively taking place.

The all-solid-state battery indicates a battery in which a liquid electrolyte used in the lithium-ion battery is replaced with a solid electrolyte. The all-solid-state battery does not use a combustible solvent therein. Therefore, ignition or explosion caused by decomposition of the conventional or existing electrolytic solution does not occur. Thus, the all-solid-state battery may be greatly improved in terms of safety. Further, since lithium (Li) metal or an alloy thereof may be used as a negative electrode material of the all-solid-state battery, the all-solid-state battery is greatly improved in terms of energy density.

The cells of the all-solid-state battery undergo a charge and discharge test during the manufacturing process thereof so as to determine the performance and quality of the cells in the same manner as the cells of a lithium ion battery. In general, the charge and discharge test of battery cells is performed under the condition that the battery cells are pressed at a designated pressure in order to suppress expansion of the battery cells.

The all-solid-state battery cells require a higher and more uniform pressure than the lithium ion battery cells to suppress expansion of the cells. Therefore, it is necessary to measure not only the overall pressure of the all-solid-state battery cell but also changes in partial pressures.

A conventional or existing pressure measurement apparatus for battery cells is configured to measure pressure through a plurality of load cells. As the average pressure of flat panels on the respective load cells is measured, the pressure of a corresponding flat panel is found out through one representative value. Further, pressure imbalance may be caused by the reaction force of support parts due to a split flat panel or the shape of the load cells.

Further, as existing technologies are mostly focused on the uniform pressing technology to increase interfacial contact safety of a solid electrolyte, development of technologies regarding a method for evaluating uniform pressing is insufficient now.

The above information disclosed in this Background section is only to enhance understanding of the background of the present disclosure. Therefore, the Background section may contain information that does not form the prior art that is already known to a person of ordinary skill in the art.

### SUMMARY OF THE DISCLOSURE

The present disclosure has been made in an effort to solve the above-described problems associated with the prior art. It is an object of the present disclosure to provide a system and a method for estimating pressure distribution of a battery cell which evaluate distribution of pressure applied to the battery cell due to applied loads during the pressure test of the battery cell.

In one aspect, the present disclosure provides a method for estimating pressure distribution of a battery cell. The method includes disposing the battery cell in a pressing apparatus and pressing the battery cell, measuring strains by strain sensors provided in the pressing apparatus, and estimating a pressure distribution applied to the battery cell based on the strains.

Other aspects and embodiments of the present disclosure are discussed below.

The above and other features of the present disclosure are discussed below.

### BRIEF DESCRIPTION OF THE DRAWINGS

The above and other features of the present disclosure are now described in detail with reference to certain embodiments thereof illustrated in the accompanying drawings, which are given hereinbelow by way of illustration only and thus do not limit the present disclosure, and wherein:

FIG. 1 is a perspective view of a pressing apparatus according to one embodiment of the present disclosure;

FIG. 2 is a front view of FIG. 1;

FIG. 3 is a perspective view of a fixing jig of the pressing apparatus according to one embodiment of the present disclosure;

FIG. 4 is a perspective view of a pressing member of the pressing apparatus according to one embodiment of the present disclosure;

FIG. 5 is a perspective view showing the lower part of the pressing member of the pressing apparatus according to one embodiment of the present disclosure;

FIG. 6 is a view showing the arrangements of strain sensors of the pressing apparatus according to one embodiment of the present disclosure;

FIG. 7 is a flowchart representing a method for estimating pressure distribution according to one embodiment of the present disclosure; and

FIGS. 8A and 8B are views illustrating load imbalance of support parts.

It should be understood that the appended drawings are not necessarily to scale, presenting a somewhat simplified representation of various features illustrating the basic principles of the present disclosure. The specific design features of the embodiments of the present disclosure as disclosed herein, including, for example, specific dimensions, orientations, locations, and shapes, will be determined in part by the particular intended application and use environment.

In the figures, the same reference numbers refer to the same or equivalent parts of the present disclosure throughout the several figures of the drawing.

### DETAILED DESCRIPTION

Specific structural or functional descriptions in embodiments of the present disclosure set forth in the following description are given to describe the embodiments of the present disclosure, and the present disclosure may be embodied in many alternative forms. Further, it should be understood that the present disclosure should not be construed as being limited to the embodiments set forth herein. The embodiments of the present disclosure are provided only to completely disclose the inventive concepts and cover modifications, equivalents, or alternatives, which should come within the scope and technical range of the present disclosure.

In the following description of the embodiments, terms, such as “first” and “second”, are used only to describe various elements, and these elements should not be construed as being limited by these terms. These terms are used only to distinguish one element from other elements. For example, a first element described hereinafter may be termed as a second element, and similarly, a second element described hereinafter may be termed as a first element, without departing from the scope of the present disclosure.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present. Other words used to describe relationships between elements should be interpreted in a like fashion, e.g., “between” versus “directly between,” “adjacent” versus “directly adjacent,” etc.

Wherever possible, the same reference numbers are used throughout the drawings to refer to the same or like parts. The terminology used herein is for the purpose of describing particular embodiments only and is not intended to be limiting. As used herein, singular forms may be intended to include plural forms as well, unless the context clearly indicates otherwise. The terms “comprises,” “comprising,” “including,” and “having,” and variations thereof, are inclusive and therefore specify the presence of stated features, integers, steps, operations, elements, components, and/or combinations thereof. However, such terms do not preclude the presence or addition of one or more other features, integers, steps, operations, elements, components, and/or combinations thereof.

Hereinafter, the present disclosure is described in detail with reference to the accompanying drawings.

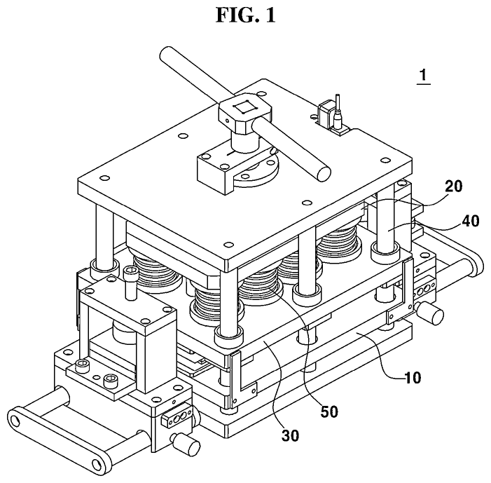

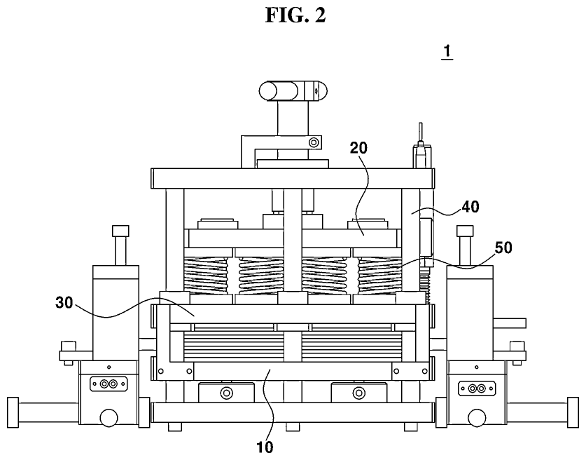

As shown in FIGS. 1 and 2, a pressing apparatus 1 for batteries according to one embodiment of the present disclosure includes a fixing jig 10, a rotary fixing jig 20, a pressing member 30, fixing members 40, and springs 50. According to an embodiment, the pressing apparatus 1 may be a uniaxial pressing apparatus.

The fixing jig 10 is fixed to the pressing apparatus 1. The fixing jig 10 is configured such that a battery cell C is mounted on the fixing jig 10. In an embodiment, the battery cell C is configured to be mounted at the center of the fixing jig 10. The rotary fixing jig 20 is connected to a bolt tightening part and is configured to move the pressing member 30 towards the fixing jig 10 or to move the pressing member 30 in a direction opposite to the fixing jig 10. The pressing member 30 is connected to the rotary fixing jig 20 by the springs 50 and is raised or lowered by rotation of the bolt tightening part. In other words, the pressing member 30 is configured to move upward and downward in the pressing apparatus 1. However, horizontal movement of the pressing member 30 is restricted.

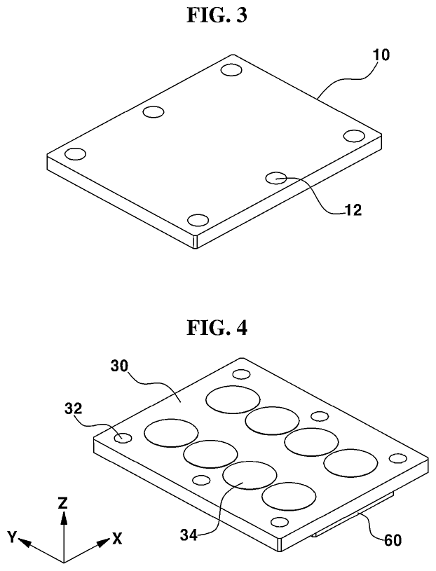

The pressing apparatus 1 includes a plurality of fixing members 40. The fixing members 40 fix the fixing jig 10 within the pressing apparatus 1. The pressing member 30 is configured to be movable upward and downward along the fixing members 40. As shown in FIG. 3, a plurality of holes 12 is provided in the perimeter of the fixing jig 10. The holes 12 may be provided to be spaced apart from each other by a designated distance along the perimeter of the fixing jig 10. Further, as shown in FIG. 4, the pressing member 30 includes a plurality mount holes 32 formed therethrough. The holes 12 and the mount holes 32 are configured to be aligned with each other when the fixing jig 10 and the pressing member 30 overlap each other. The fixing members 40 pass through the holes 12 of the fixing jig 10 and the mount holes 32 of the pressing member 30. The fixing members 40 prevent horizontal and vertical movement of the fixing jig 10 and allow the pressing member 30 to be mounted thereon and to be movable in the vertical direction of the pressing apparatus 1. In one embodiment, the fixing members 40 may be cylindrical.

As described above, the pressing member 30 is connected to the bolt tightening part and the rotary fixing jig 20 by a plurality of springs 50. In an embodiment, the springs 50 are supported by discs 34 provided on the pressing member 30. Referring to FIG. 4, a plurality of discs 34 is provided on the upper surface of the pressing member 30, and the discs 34 may have a circular shape.

According to the present disclosure, pressure applied to the cell C is determined by loads due to the springs 50. The same displacement is applied by the respective springs 50, so that uncertainty factors of pressure in the respective parts of the cell C are restricted by the modulus of elasticity of the springs 50. Further, pressure is applied to the central part of the pressing member 30 by point loads due to the springs 50 from above the pressing member 30. In this case, the circular discs 34 may be used to apply uniform distribution of loads to the lower part of the pressing member 30. In the case in which the discs 34 are formed in an angled shape, load concentration may occur particularly when the angle of the discs 34 is small.

According to the present disclosure, the cell C generally has a rectangular shape. Thus the discs 34 may be disposed in an even number per axis so as to be symmetrical based on plane directions, i.e., symmetrical about the X-axis and the Y-axis). In consideration of uncertainty about load distribution depending on increase in the size of the discs 34 at the positions of the loads and uncertainty depending on increase in the number of positions where loads are applied, the number of the positions of the loads per axis and the size of the pressing member 30 may be determined through optimization of these two factors. Although the drawings illustrate eight discs 34, the number of the discs 34 is not limited thereto.

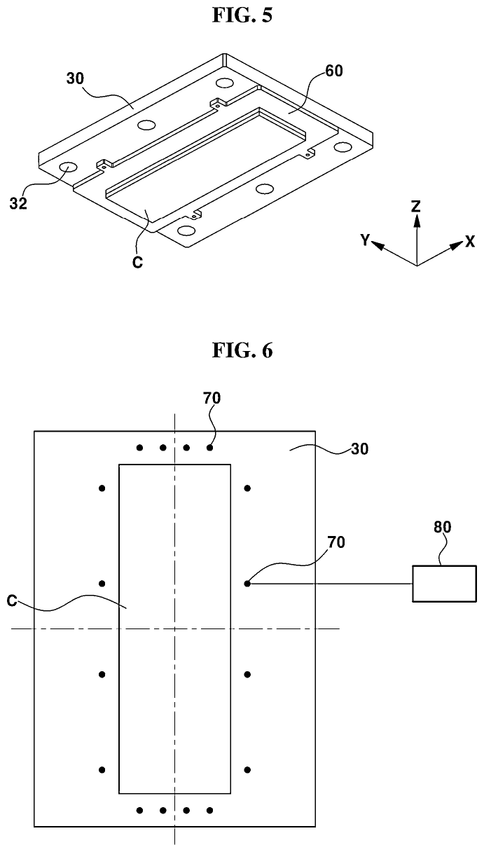

As shown in FIG. 5, the pressing apparatus 1 may further include an insulation plate 60. The insulation plate 60 may be installed on the lower surface of the pressing member 30.

As shown in FIG. 6, the pressing apparatus 1 according to the present disclosure may include a plurality of strain sensors 70. The strain sensors 70 are mounted on the lower surface of the pressing member 30, which comes into contact with the battery cell C. When the insulation plate 60 is mounted on the lower surface of the pressing member 30 as shown in FIG. 5, the strain sensors 70 are installed on the lower surface of the insulation plate 60. In other words, the strain sensors 70 are mounted on the surface of a member, which comes into direct contact with the battery cell C. The strain sensors 70 may be disposed as close as possible to the battery cell C and may be installed not to come into direct contact with the battery cell C depending on the specification of the strain sensors 70. The strain sensors 70 are configured to measure the strain of the pressing member 30 or the insulation plate 60 around the battery cell C.

The battery cell C may have a geometrically symmetrical structure, but the battery cell C may not be substantially symmetrical by electrochemical reaction which may occur therein. Therefore, the strain sensors 70 are configured to be installed around the entire perimeter of the battery cell C without axisymmetric analysis. Here, orthogonal sampling may be used as a sampling method, and the strain sensors 70 may be disposed at the same interval at each edge of the battery cell C.

The pressing apparatus 1 further includes a controller 80. The controller 80 is configured to collect measured data from the strain sensors 70 and to perform various calculations to estimate pressure distribution.

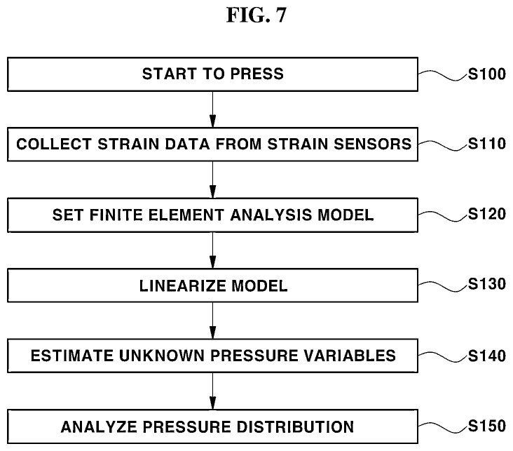

Hereinafter, a method for estimating pressure distribution of the battery cell C by the pressing apparatus 1 is described with reference to FIG. 7.

In Operation S100, the pressing apparatus 1 starts to press the battery cell C. The pressing apparatus 1 is configured to apply pressure to the battery cell C using a predetermined pressing force. As one non-restrictive example, the pressing force may be set to 16 kilonewtons (kN). The pressing apparatus 1 starts to press the cell C, while moving the pressing member 30 toward the cell C mounted on the fixing jig 10 by rotation of the bolt tightening part.

When the pressing apparatus 1 starts to press the cell C, the strain sensors 70 measures the strains of the cell C at respective positions where the strain sensors 70 are installed, in Operation S110. The measured strain data is transmitted to the controller 80. As the strain data, it may be desirable to use strain measurements taken after loads and the strain measurements are stabilized after starting to press the cell C.

In Operation S120, the finite element analysis model of the pressing apparatus 1 is constructed. Since a model constructed using the entirety of the uniaxial pressing apparatus causes an increase in expenses necessary for calculation, domains of the analysis model are limited to include factors directly affected by pressing conditions. In one embodiment of the present disclosure, the domains are set to include the pressing member 30 and/or the insulation plate 60 and the battery cell C of the pressing apparatus 1, which are affected directly by pressure. Further, a linear elastic finite element analysis model for simulating deformation due to loads is constructed. The finite element analysis model of the pressing apparatus 1 includes physical parameters including physical properties of constituent materials and geometrical values in the pressing apparatus 1, the positions of the strain sensors 70, etc.

In Operation S130, linearization of the acquired analysis model is performed. As load conditions of the analysis model, three factors, i.e., (i) vertical loads z₁, z₂, z₃, z₄, z₅, z₆, z₇ and z₈ due to the loads of the springs 50, (ii) horizontal reaction forces x₁, x₂, x₃, x₄, x₅, x₆, y₁, y₂, y₃, y₄, y₅ and y₆ of the fixing members 40, and (iii) reaction forces P(x,y) due to unbalanced contact of the surface of the cell C, are set. Here, the reaction force P(x,y) may be expressed as the following Equation 1. Further, unknown pressure variables θ are set to z₁, z₂, z₃, z₄, z₅, z₆, z₇, z₈, x₁, x₂, x₃, x₄, x₅, x₆, y₁, y₂, y₃, y₄, y₅, y₆, a, b, c, d, q, e and f.

P(x,y)=P₀+ax+by+cx²+dy²+qxy+ex²y+fxy² [Equation 1]

In Equation 1, P₀ is an initial pressure value of the analysis model.

In the case of the vertical loads z₁, z₂, z₃, z₄, z₅, z₆, z₇ and z₈ due to the loads of the springs 50, imbalance in loads applied to the pressing member 30 may be caused by an error in the springs 50 or the rotary fixing jig 20.

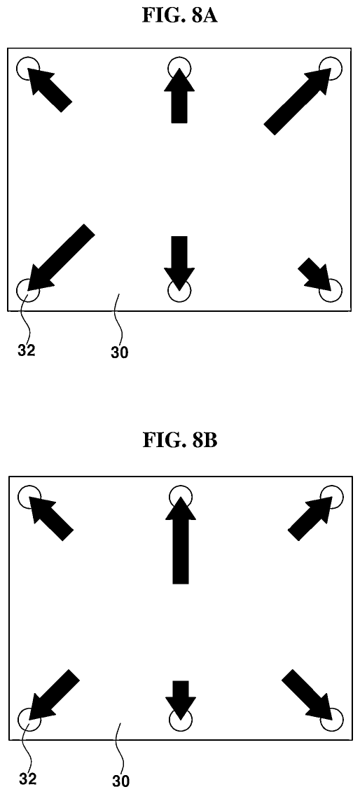

As shown in FIGS. 8A and 8B, imbalance in the loads on fixing members 40, which are support parts, may occur. In case of the horizontal reaction forces x₁, x₂, x₃, x₄, x₅, x₆, y₁, y₂, y₃, y₄, y₅ and y₆ of the fixing members 40, the fixing members 40 are installed at positions spaced apart from the central point of the pressing member 30 by a designated distance. The loads on these fixing members 40 are referred to support part loads. When the pressing member 30 is mounted on the fixing members 40, movement of the pressing member 30 in the horizontal direction, i.e., in the X-axis or Y-axis direction, is restricted by the shape of the fixing members 40, but movement of the pressing member 30 in the vertical direction is not restricted.

Further, the reaction forces P(x,y) due to unbalanced contact of the surface of the cell C may be caused by unbalanced contact between the pressing member 30 and the cell C or between the insulation plate 60 and the cell C.

Subsequently, in Operation S130, strain responses of the respective strain sensors 70 with respect to unit change of the respective unknown pressure variables θ in an initial value y₀ of the analysis model are extracted as a basis reaction vectors. The analysis model εₚᵣₑ may be linearized through the following process using linear combinations between the unknown pressure variables θ and the basis reaction vectors ε_{c}, by the following Equation 2.

$${ε}_{pre} ( {F}_{x} ( {x}_{1} , {x}_{2} , … , {x}_{6} ) , {F}_{y} ( {y}_{1} , {y}_{2} , … , {y}_{6} ) , {F}_{z} ( {z}_{1} , {z}_{2} , … , {z}_{8} ) , P ( x , y ) )$$

$$\approx {y}_{0} + a {ε}_{pre , x} + b {ε}_{pre , y} + c {ε}_{pre , {x}^{2}} + … + {\sum }_{i} {x}_{i} {ε}_{pre , i} + {\sum }_{j} {y}_{j} {ε}_{pre , j} + {\sum }_{n} {z}_{n} {ε}_{pre , n}$$

$$= {y}_{0} + [ \begin{matrix}{ε}_{F 11 , x} \\ {ε}_{F 12 , x} \\ … \\ {ε}_{S 13 , x}\end{matrix} ] a … + [ \begin{matrix}{ε}_{F 11 , {x}_{1}} \\ {ε}_{F 12 , {x}_{1}} \\ … \\ {ε}_{S 13 , {x}_{1}}\end{matrix} ] {x}_{1} + … + [ \begin{matrix}{ε}_{F 11 , {x}_{6}} \\ {ε}_{F 12 , {x}_{6}} \\ … \\ {ε}_{S 13 , {x}_{6}}\end{matrix} ] {x}_{6} + [ \begin{matrix}{ε}_{F 11 , {y}_{1}} \\ {ε}_{F 12 , {y}_{1}} \\ … \\ {ε}_{S 13 , {y}_{1}}\end{matrix} ] {y}_{1} + … + [ \begin{matrix}{ε}_{F 11 , {y}_{6}} \\ {ε}_{F 12 , {y}_{6}} \\ … \\ {ε}_{S 13 , {y}_{6}}\end{matrix} ] {y}_{6} + [ \begin{matrix}{ε}_{F 11 , {z}_{1}} \\ {ε}_{F 12 , {z}_{1}} \\ … \\ {ε}_{S 13 , {z}_{1}}\end{matrix} ] {z}_{1} + … [ \begin{matrix}{ε}_{F 11 , {z}_{8}} \\ {ε}_{F 12 , {z}_{8}} \\ … \\ {ε}_{S 13 , {z}_{8}}\end{matrix} ] {z}_{8}$$

$$= {y}_{0} + [ \begin{matrix}\begin{matrix}{ε}_{F 11 , x} \\ {ε}_{F 12 , x} \\ … \\ {ε}_{S 13 , x}\end{matrix} & … & \begin{matrix}{ε}_{F 11 , {x}_{1}} \\ {ε}_{F 12 , {x}_{1}} \\ … \\ {ε}_{S 13 , {x}_{1}}\end{matrix} & … & \begin{matrix}{ε}_{F 11 , {x}_{6}} \\ {ε}_{F 12 , {x}_{6}} \\ … \\ {ε}_{S 13 , {x}_{6}}\end{matrix} & … & \begin{matrix}{ε}_{F 11 , {y}_{6}} \\ {ε}_{F 12 , {y}_{6}} \\ … \\ {ε}_{S 13 , {y}_{6}}\end{matrix} & … & \begin{matrix}{ε}_{F 11 , {z}_{8}} \\ {ε}_{F 12 , {z}_{8}} \\ … \\ {ε}_{S 13 , {z}_{8}}\end{matrix} ]\end{matrix} [ \begin{matrix}a \\ … \\ {x}_{1} \\ {x}_{2} \\ … \\ {z}_{8}\end{matrix} ] = {y}_{0} + {ε}_{c} θ$$

In Equation 2, Fₓ and F_{y} indicate reaction force in the X-axis direction and reaction force in the Y-axis direction among the horizontal reaction forces, respectively, and F_{z} indicates vertical load. The respective vectors indicate the responses of the strain sensors 70 when there is a unit change in the respective unknown pressure variables θ. In this example, a total of 16 subscripts F11, F12, . . . , B13 indicate the respective responses of 16 strain sensors 70.

εₚᵣₑ=y₀+ε_{c}θ [Equation 2]

Further, in Operation S140, the unknown pressure variables θ are estimated. As set forth in the following Equation 3, the unknown pressure variable 0 may be calculated by inputting strain data εm measured through least squares estimation.

θ=(ε_{c}^{T}ε_{c})⁻¹ε_{c}^{T}(εₘ−y₀) [Equation 3]

In Operation S150, pressure distribution is analyzed. A matching degree is derived through strain responses by inputting the estimated unknown pressure variables θ to the analysis model. Pressure responses of the cell C may be derived from the model to which the estimated unknown pressure variables θ are input.

Particularly, the system and the method for estimating pressure distribution according to the present disclosure may be applied to the pressure test not only of a lithium ion battery but also of an all-solid-state battery.

According to the present disclosure, a representative value of pressures on a battery cell being pressed is not measured, but the pressure distribution on the entire battery cell is estimated. Accordingly, a partial pressure may be easily attained and understood, and a cause of unbalanced pressure distribution may be easily analyzed.

Further, according to the present disclosure, the strain sensors are not directly adhered to the battery cell and thus do not affect pressure transmission paths. Thus, the effects of the strain sensors may be minimized.

As should be apparent from the above description, the preset disclosure provides a system and a method for estimating pressure distribution of a battery cell. The system and the method evaluate distribution of pressure applied to the battery cell due to applied loads during the pressure test of the battery cell.

The present disclosure has been described in detail with reference to embodiments thereof. However, it should be appreciated by those having ordinary skill in the art that changes may be made in these embodiments without departing from the principles and spirit of the present disclosure, the scope of which is defined in the appended claims and their equivalents.

What is claimed is:

1. A method for estimating pressure distribution of a battery cell, the method comprising:
disposing the battery cell in a pressing apparatus and pressing the battery cell;
measuring strains by strain sensors provided in the pressing apparatus; and
estimating a pressure distribution applied to the battery cell based on the strains.

2. The method of claim 1, wherein the strain sensors are configured to measure strains on a surface pressing the battery cell in the pressing apparatus.

3. The method of claim 1, wherein the strain sensors are disposed at a part of the pressing apparatus configured to directly press the battery cell and positioned in the part to surround a perimeter of the battery cell.

4. The method of claim 3, wherein the strain sensors are disposed at the part of the pressing apparatus to be spaced apart from each other at a predetermined interval.

5. The method of claim 3, wherein the battery cell is provided as a hexahedron, and
wherein the strain sensors are disposed at the same interval at each edge of a surface of the hexahedron configured to come into contact with the pressing apparatus.

6. The method of claim 1, wherein the estimating the pressure distribution comprises:
setting unknown pressure variables from load conditions of the pressing apparatus;
estimating the unknown pressure variables based on the measured strains; and
estimating the pressure distribution based on the estimated unknown pressure variables.

7. The method of claim 6, further comprising setting and linearizing an analysis model comprising physical characteristics of the pressing apparatus.

8. The method of claim 7, wherein the analysis model is linearized based on the strains measured in response to a unit change of the unknown pressure variables.

9. The method of claim 1, wherein, in the estimating the unknown pressure variables, the unknown pressure variables are estimated using least squares estimation.

10. The method of claim 7, wherein the pressure distribution of the battery cell is acquired by inputting the estimated unknown pressure variables to the analysis model.

11. The method of claim 6, wherein the pressing apparatus comprises:
a pressing member configured to press the battery cell;
a plurality of springs configured to apply loads to the pressing member; and
a plurality of fixing members configured to allow the pressing member to be mounted thereon to be movable.

12. The method of claim 11, wherein the strain sensors are disposed on a surface of the pressing member configured to face the battery cell and are disposed around a perimeter of the battery cell not to come into contact with the battery cell.

13. The method of claim 11, wherein the load conditions comprise at least one of vertical loads due to loads of the springs, horizontal reaction forces of the fixing members, or reaction forces due to unbalanced contact on a surface of the battery cell.

14. The method of claim 11, wherein the pressing member includes a plurality of discs formed on a surface thereon, and each of the springs is disposed on a corresponding one of the plurality of discs.

15. The method of claim 14, wherein the plurality of discs has a circular shape.

16. The method of claim 14, wherein the plurality of discs is provided in an even number.

17. The method of claim 11, wherein the pressing apparatus further comprises a fixing jig configured to mount the battery cell thereon and fixedly mounted on the fixing members.

18. The method of claim 1, wherein the battery cell is an all-solid-state battery cell.
